(19) United States
(12) Patent Application Publication
(10) Pub. No.: US 2014/0106034 A1
(43) Pub. Date: Apr. 17, 2014

(54) METHOD FOR THE PRODUCTION OF CANDIED FRUIT AND VEGETABLES AND DRIED FRUIT AND VEGETABLES WITHOUT SUCROSE BY USING SUCROSE SUBSTITUENT AGENTS AND RESPECTIVE CANDIED FRUIT AND VEGETABLES

(71) Applicants: Pilar Dos Santos, Tabuaco (PT); Fernando Hermínio Ferreira Milheiro Nunes, Vila Real (PT); Ana Isabel Ramos Novo Amorim De Barros, Vila Real (PT)

(72) Inventors: Pilar Dos Santos, Tabuaco (PT); Fernando Hermínio Ferreira Milheiro Nunes, Vila Real (PT); Ana Isabel Ramos Novo Amorim De Barros, Vila Real (PT)

(73) Assignees: DOUROMEL - FÁBRICA DE CONFEITARIA, LDA., Tabuaço (PT); UNIVERSIDADE DE TRÁS-OS-MONTES E ALTO DOURO, Vila Real (PT)

(21) Appl. No.: 14/114,196

(22) PCT Filed: Apr. 30, 2012
(86) PCT No.: PCT/IB2012/052152

§ 371 Date: Dec. 19, 2013

(30) Foreign Application Priority Data
Apr. 29, 2011 (PT) 105662

(51) Int. Cl. A23G 3/38; A23L 1/212; A23G 3/54

(52) U.S. Cl. CPC A23G 3/38; A23G 3/54; A23L 1/212
USPC 426/102; 426/307; 426/250; 426/242; 426/303

(57) ABSTRACT

The present invention relates to a process for the production of candied fruit and vegetables without sucrose, by immersing the fruit and vegetables previously prepared in candied solutions containing sucrose substituent agents. The sucrose substituent agents may or may not have other functional properties in addition to their sweet flavor. The resulting candied products may be subject to further processing in order to reduce water content, thus resulting in dried fruit or vegetables without sucrose, with or without additional functional properties.

### FIELD OF INVENTION

The present invention relates to a process for the production of candied fruit and vegetables without sucrose, by means of immersing the fruit and vegetables previously prepared in candying solutions containing sucrose substituent agents with specific nutritional properties, including low glycemic index, low calorie content or functional properties such as being rich in dietary fiber.

To this end, use is made of candying solutions initially containing 15 to 40 g candying agent per 100 g candying solution, and of a gradual increase in the candying agent concentration up to a final value of 65 to 75 g candying agent per 100 g solution. As candying agents used can be made of ingredients other than sucrose, such as fructose, mannose, galactose, galactosamine, sorbitol, xylitol, maltitol, erythritol, lactitol as sweet candying agents and fructo-oligosaccharides, manno-oligosaccharides, galacto-oligosaccharides, gluco-oligosaccharides, xylo-oligosaccharides, pectin-oligosaccharides or other oligosaccharides having a dietary fiber function. The candying agents may be used individually or in combination. The candied products resulting from the process described can be subject to a step of removing excess water such as natural drying, hot air drying, infrared drying, microwave or lyophilization drying, resulting in dried fruit and vegetables without sucrose.

### BACKGROUND OF THE INVENTION

The fruit and vegetables are naturally healthy food products, but with a reduced lifetime. Osmotic dehydration is a technique that simultaneously reduces the water content of the food product and increases the dry matter content therein, by immersing the fruit as a whole or in pieces, in concentrated solutions of compatible substances with the material to be treated, thus reducing the products' water activity and increasing the lifetime thereof. Subsequently to the contact between the material and the solution, three spontaneous material transfer streams are formed: a stream from the food product into the solution, corresponding to a main water stream, and a minor stream of solutes capable of passing through the semi-permeable membranes of the food product cells and, in the opposite direction, some of the solutes in the solution are transferred to the food product.

The demand for healthy, processed, natural and tasty fruits increases every year, not only as end products, but also as ingredients to be included in other food products containing fruit such as ice-cream, cereals, dairy products, confectionery and baked goods.

The sensory and functional characteristics in candied products (prepared by osmotic dehydration) turn these partially-dehydrated fruit products into attractive ingredients, as they present the cellular structure of an intact fruit. The candied products have improved texture, an appreciated flavor (due to the increase on sugar acid ratio), aroma and color stability. However, these products are also often caloric when produced by osmotic dehydration using sucrose concentrated solutions (ordinary process), which limits the attractiveness of these products. The candying process used today uses sucrose solutions or mixtures of sucrose with glucose to final concentrations ranging from 50 to 70 g sugar per 100 g solution (U.S. Pat. No. 4,041,184; U.S. Pat. No. 4,778,681; European Patent 0384238A2; Falade and Igbeka, 2007; Shi and Maguer 2002; Khin et al. 2005), resulting in products with a high calorie content, and high glycemic index.

In recent years, the nutrition paradigm has changed significantly, shifting its focus mainly onto a balanced diet for an “optimal” nutrition, i.e., maximizing the lifetime and quality by identifying food ingredients, which increase the ability to resist disease and improve health, when added to a balanced diet. These reasons have led both end users and the manufacturing industry to demand increasingly “healthy” products.

The present invention relates to a process for the production of candied fruit and vegetables without sucrose, by means of the immersion of the fruit and vegetables previously prepared in candying solutions containing sucrose substituent agents, such as, among others: fructose, mannose, galactose, galactosamine, sorbitol, xylitol, maltitol, erythritol, lactitol, fructo-oligosaccharides, manno-oligosaccharides, galacto-oligosaccharides, gluco-oligosaccharides, xylo-oligosaccharides, pectin-oligosaccharides or other oligosaccharides. The candying agents may be used individually or in combination.

The ingredients used as candying agents have specific nutritional properties, namely: low glycemic index (all ingredients), reduced calorie content (except fructose) or functional dietary fiber properties (lactitol, maltitol, fructo-oligosaccharides, manno-oligosaccharides, galacto-oligosaccharides, gluco-oligosaccharides, xylo-oligosaccharides, pectin-oligosaccharides). Dietary fibers are generally defined as food components, which are not digested by enzymes in the human gastrointestinal system, and they may or may not be fermented in the colon. According to CODEX ALIMENTARIUS, dietary fiber means carbohydrate polymers with a degree of polymerization not inferior to 3, which are not digested nor absorbed in the small intestine (FAO/WHO, 1997; Champ et al., 2003). The health benefits resulting from the consumption of dietary fibers are well documented, presenting a beneficial effect as regards intestinal transit time, constipation prevention and treatment, colorectal cancer, coronary heart disease and diabetes (Eastwood, 1987; Mendeloff, 1987; Harig, 1989, Tinker, 1991; Anderson, 1994; Cassidy and Bingham, 1994), production of short-chain fatty acids by their fermentation in the colon, thus promoting the health of the colon, stimulating beneficial intestinal microflora growth, acting as prebiotics (Roediger, 1980; Cummings, 1981; Fleming et al., 1983; Cummings, 1984; McBurney et al. 1985; McBurney et al., 1987; Mendeloff, 1987; Mortensen et al., 1988; Schweizer. et al, 1991; Demigne et al., 1995).

The products resulting from this process have a water content, water activity, dry matter content, texture and flavor with characteristics similar to those of conventional candied products, i.e., the previous candying processes using sucrose and mixtures of sucrose with glucose.

Candied products may be subject to subsequent processes for water removal, such as by natural drying, hot air drying, infrared drying, microwave or lyophilization drying, resulting in dried fruit and vegetables without sucrose, providing a flavor and texture similar to those of conventional dry products.

### DETAILED DESCRIPTION OF THE INVENTION

Candied fruit and vegetables are typically manufactured by using candying solutions consisting of sucrose, or mixtures of sucrose and glucose. Although exhibiting some characteristics appreciated by consumers, such as the sweet flavor, texture and the high shelf life due to a low water content and a high dry matter content, and consequently a low water activity, these products contain a high caloric content and a high glycemic index, thus turning them into nutritionally unbalanced products.

The present invention allows obtaining candied fruit and vegetables with the appropriate technological and organoleptic characteristics, but with increased balanced nutritional characteristics, i.e. a reduction in caloric content and/or glycemic index as well as the introduction of functional ingredients with dietary fiber properties.

The candying process can be applied to all kinds of fruit and vegetables, including cherries, figs, pineapple, peach, citron, orange peel, orange slices, pear, pumpkin, turnip, carrot. Fruit and vegetables can be candied with or without the addition of food-coloring agents. The temperature of the candying process may range from room temperature up to 85° C. The candying process can be carried out continuously or discontinuously, with or without stirring, a candying solution being initially used containing a candying agent at a concentration of 15 to 45 g per 100 g solution and a final concentration of 55 g to 75 g candying agent per 100 g solution. The candying agents alternative to sucrose may be, among others, fructose, mannose, galactose, galactosamine, sorbitol, xylitol, maltitol, erythritol, lactitol, fructo-oligosaccharides, manno-oligosaccharides, galacto-oligosaccharides, gluco-oligosaccharides, xylo-oligosaccharides, pectin-oligosaccharides or other oligosaccharides.

The candying agents may be used individually or in combination, depending on the characteristics of the desired product, for example, for the production of a candied product with low caloric content and low glycemic index, but with sweetness similar to sucrose, one may use among others sorbitol, xylitol, maltitol. For the production of candied products having a low glycemic index, but with a caloric content similar to sucrose, one may use, among others, fructose. For the production of candied products having a high dietary fiber content and low glycemic index, one may use among others fructo-oligosaccharides, manno-oligosaccharides, galacto-oligosaccharides, gluco-oligosaccharides, xylo-oligosaccharides, pectin-oligosaccharides.

Candied products may be subject to a subsequent process for water removal such as by natural drying, hot air drying, infrared drying, microwave or lyophilization drying, among others, resulting in dried fruit and vegetables with nutritional characteristics which depend on the fruit and vegetables used, for example, if the candied products result from the use of ingredients with dietary fiber properties, the final dry product shall also be rich in dietary fiber. The characteristics of the final products will also depend on the drying process used, for example, for the preservation of the nutritional characteristics of the dry product, minimal modification of the flavor, lyophilization process shall be the appropriate process. For a more cost-effective process, the drying tunnels are preferred, although leading to a change in color and odor when compared to lyophilization.

TABLE 1
Examples of Compositions (g/100 g) of different
fruit and vegetables candied with sorbitol

| | | | | | | | Total | Energy^{a} |
|---|---|---|---|---|---|---|---|---|
| | % Water | a_{w} | Sorbitol | Sucrose | Fructose | Glucose | Sugars | kcal/100 g |
| Pineapple | 35.5 ± 0.1 | 0.820 | 59.2 | 0.0602 | 0.931 | 0.938 | 61.1 | 122 |
| Whole | 39.5 ± 0.1 | 0.857 | 47.0 | 0.0169 | 0.130 | 0.0826 | 47.2 | 94 |
| Pear | | | | | | | | |
| Orange | 31.9 ± 0.2 | 0.804 | 58.7 | 0.0802 | 0.0497 | 0.101 | 58.9 | 118 |
| Peel | | | | | | | | |
| Orange | 34.8 ± 0.2 | 0.819 | 49.4 | 0.865 | 1.20 | 1.45 | 53.0 | 106 |
| Slice | | | | | | | | |
| Citron | 38.3 ± 0.6 | 0.824 | 55.8 | 0.0137 | 0.153 | 0.210 | 56.1 | 112 |
| Fig | 34.7 ± 0.1 | 0.823 | 64.0 | 0.0234 | 0.0892 | 0.137 | 64.3 | 129 |
| Cherry | 31.9 ± 0.4 | 0.798 | 60.9 | 0.0100 | 0.387 | 0.570 | 61.9 | 124 |
| Peach | 34.9 ± 0.2 | 0.830 | 51.2 | 0.0472 | 0.195 | 0.236 | 51.7 | 103 |
| White | 33.0 ± 0.0 | 0.805 | 66.1 | 0.0570 | 0.0850 | 0.120 | 66.4 | 133 |
| Pumpkin | | | | | | | | |

^{a}in kcal = 4x(g protein + g carbohydrates) + 9x(g lipids) + 2x(sweeteners) or in kJ = 17x(g protein + g carbohydrates) + 37x(g lipids) + 8.5x(g sweeteners).

TABLE 2
Color Examples of fruit candied with sorbitol

| | L* | a* | b* | ΔC* | ΔE* |
|---|---|---|---|---|---|
| Pineapple | 38.52 ± 1.34 | −0.14 ± 0.11 | 13.80 ± 0.14 | 1.42 | 1.42 |
| Whole Pear | 27.25 ± 0.49 | 0.17 ± 0.11 | 1.59 ± 0.06 | 0.36 | 5.41 |
| Orange Peel | 40.64 ± 1.69 | 0.00 ± 0.23 | 21.54 ± 0.66 | 8.14 | 11.02 |
| Orange Slice | 48.23 ± 3.87 | 10.03 ± 0.99 | 40.01 ± 3.45 | 24.12 | 27.86 |
| Citron | 30.72 ± 1.51 | −2.50 ± 0.37 | 8.64 ± 1.01 | 5.35 | 9.08 |
| Fig | 26.27 ± 0.81 | −0.06 ± 0.21 | 2.31 ± 0.47 | 0.97 | 4.07 |
| Cherry | 29.35 ± 0.97 | 9.74 ± 0.80 | 5.42 ± 0.47 | 3.57 | 6.19 |
| Peach | 35.27 ± 1.17 | −0.95 ± 0.38 | 19.27 ± 1.13 | 12.90 | 16.88 |
| White | 59.44 ± 1.24 | −0.94 ± 0.12 | 7.92 ± 0.25 | 1.98 | 13.85 |
| Pumpkin | | | | | |

TABLE 3
Examples of texture profile Analysis of fruit
candied with Sorbitol

| | Hardness | Breakability | Elasticity | Adhesiveness | Cohesiveness | Chewebility |
|---|---|---|---|---|---|---|
| Pear | 59.955 | 38.277 | 0.35544 | −43.051 | 0.10381 | 2.2122 |
| Orange | 92.013 | 72.102 | 0.52177 | −66.020 | 0.23987 | 11.516 |
| Peel | | | | | | |
| Orange | 122.28 | 33.990 | 0.52333 | −170.51 | 0.35851 | 22.942 |
| Slice | | | | | | |
| Citron | 73.870 | 69.447 | 0.28361 | −66.315 | 0.10307 | 2.1593 |
| Fig | 105.77 | 32.518 | 0.19900 | −441.41 | 0.21262 | 4.4755 |
| Cherry | 42.974 | 9.0370 | 0.68038 | −96.389 | 0.29843 | 8.7257 |
| Peach | 70.301 | 82.860 | 0.18594 | −8.7400 | 0.15721 | 2.0551 |
| White | 31.413 | 30.010 | 0.42799 | −47.760 | 0.087102 | 1.1710 |
| Pumpkin | | | | | | |

TABLE 4
Examples of stress, deformation and deformability
by uniaxial compression of fruit candied with sorbitol

| | σₙₒᵣₘₐₗ | εₙₒᵣₘₐₗ | τ_{cut} | γ_{cut} |
|---|---|---|---|---|
| Citron | 0.587 ± 0.081 | 0.409 ± 0.024 | 0.293 ± 0.041 | 0.614 ± 0.037 |
| Pear | 0.359 ± 0.059 | 0.305 ± 0.034 | 0.180 ± 0.030 | 0.458 ± 0.051 |
| Orange Peel | 0.357 ± 0.041 | 0.941 ± 0.147 | 0.178 ± 0.020 | 1.41 ± 0.22 |
| Peach | 0.410 ± 0.058 | 0.938 ± 0.177 | 0.205 ± 0.029 | 1.41 ± 0.27 |
| White Pumpkin | 0.267 ± 0.025 | 0.354 ± 0.081 | 0.134 ± 0.013 | 0.531 ± 0.122 |

In short, the use of candying agents alternative to sucrose allows obtaining candied products with technological (shelf life) sensorial (taste and texture) and nutritional characteristics more suitable for a healthy diet, depending on the candying agent used, a lower caloric value, low glycemic index and functional dietary fiber properties.

### EXAMPLES

For a simpler understanding of the invention examples are hereinafter described of preferred embodiments of the invention, which, however, are not intended to limit the scope of the present invention.

Hereinafter some non-limiting examples are described for the process for the production of candied fruit and vegetables without sucrose, as well as dry fruit and vegetables without sucrose.

### Example 1

Process for obtaining candied pumpkin with sorbitol, a product with lower caloric content, and low glycemic index, comprising the following steps:
preparing the candying solution with a content of 45 g sorbitol per 100 g solution
heating at 60° C.
preparing the pumpkin by peeling and cutting it into suitable-sized pieces.
placing the pumpkin into the candying solution
increasing the candying agent concentration from 5 g per 100 g solution up to 65 g sorbitol per 100 g solution every 8 hours
draining the product
storing the product in a stabilizing solution containing 65 g sorbitol per 100 g solution and 50 ppm benzoic acid and potassium sorbate.

### Example 2

Process for obtaining candied pineapple slices with fructo-oligosaccharides, a product with lower caloric content, low glycemic index, and functional dietary fiber properties, comprising the following steps:
preparing the candying solution with a content of 25 g fructo-oligosaccharides per 100 g solution.
heating at 60° C.
preparing the pineapple by peeling and cutting it into suitable-sized slices.
placing the slices into the candying solution
increasing the candying agent concentration from 10 g per 100 g solution up to 65 g fructo-oligosaccharides per 100 g solution every 8 hours
draining the product
storing the product in a stabilizing solution containing 65 g fructo-oligosaccharides per 100 g solution and 50 ppm benzoic acid and potassium sorbate.

### Example 3

Process for obtaining candied orange peel with fructose, a product with low glycemic index, comprising the following steps:
preparing the candying solution with a content of 45 g fructose per 100 g solution.
heating at 40° C.
preparing the orange peel by peeling and cutting it into the suitable size
placing the orange peels into the candying solution
increasing the candying agent concentration from 5 g per 100 g solution up to 70 g fructose per 100 g solution every 8 hours
draining the product
storing the product in a stabilizing solution containing 70 g fructose per 100 g solution and 50 ppm benzoic acid and potassium sorbate.

### Example 4

Process for obtaining candied dry fig with maltitol, a product with lower caloric content and low glycemic index, comprising the following steps:
preparing the candying solution with a content of 35 g maltitol per 100 g solution.
heating at 60° C.
preparing the fig by puncturing its surface
placing the fig into the candying solution
increasing the candying agent concentration from 5 g per 100 g solution up to 55 g maltitol per 100 g solution every 8 hours
draining the product
dehydrating the product up to a water content of 10% by lyophilization.

### Example 5

Process for obtaining dry peach with galacto-oligosaccharides, a product with lower caloric content, low glycemic index, and high functional dietary fiber properties, comprising the following steps:
preparing the candying solution with a content of 25 g galacto-oligosaccharides per 100 g solution.
heating at 50° C.
preparing the peach by peeling and cutting it into halves.
placing the peach into the candying solution
increasing the candying agent concentration from 10 g per 100 g solution up to 50 g galacto-oligosaccharides per 100 g solution every 5 hours
draining the product
dehydrating the product up to a water content of 10% per greenhouse drying under convection at 60° C.

### SUMMARY OF THE INVENTION

The present invention relates to a process for the production of candied products, comprising the following steps:
a) preparing the candying solution with a content of candying agent between 15 to 45 g per 100 g solution;
b) heating the solution prepared in the previous step;
c) preparing the product meant to be candied;
d) immersing the product meant to be candied into the solution with the candying agent;
e) gradually increasing the candying agent concentration up to a final value between 65 to 75 g candying agent per 100 g solution;
f) draining the product;
g) storing the product in a stabilizing solution containing 65 g to 75 g candying agent per 100 g solution and 50 ppm benzoic acid and potassium sorbate.

In a preferred embodiment, the candying agent is fructose, mannose, galactose, galactosamine, sorbitol, xylitol, maltitol, erythritol, lactitol as candying agents and fructo-oligosaccharides, manno-oligosaccharides, galacto-oligosaccharides, gluco-oligosaccharides, xylo-oligosaccharides, pectin-oligosaccharides or other oligosaccharides and it may be used individually or in combination.

In another preferred embodiment, the candying solution further comprises a food-coloring agent.

In a preferred embodiment, the temperature in step b) ranges from room temperature up to 85° C. and in step c) comprises the peeling and cutting of the product meant to be candied.

In yet another preferred embodiment, the process further comprises a step of removing excess water, which may be carried out by natural drying, hot air drying, infrared drying, microwave or lyophilization drying.

In yet another preferred embodiment, the product meant to be candied is a fruit (for example: cherries, figs, pineapple, peach, citron, orange peel, orange slices, or pear) or a vegetable (for example: pumpkins, turnips or carrots).

Another object of the present invention are candied products obtained by the process described above.

Yet another object of the present invention is a food product comprising the candied product described above.

### REFERENCES

Anderson J. W., Smith B. M., Guftanson N. J. (1994) Health benefits and practical aspects of high-fiber diets. American Journal of Clinical Nutrition, 59 (Suppl.), S1242-S1247.

Cassidy, A., Bingham, S. A., Cummings, J. H. (1994). Starch intake and colorectal cancer risk: an international comparison. British Journal of Cancer, 69, 937-942.

Champ M., Langkilde A.-M., Brouns F., Kettlitz B., Collet Y. L. B. (2003) Advances in dietary fibre characterisation. 1. Definition of dietary fibre, physiological relevance, health benefits and analytical aspects. Nutrition Research Reviews, 16, 71-82.

Cummings J. H. (1981) Short chain fatty acids in the human colon. Gut, 22, 763-769.

Cummings J. H. (1984) Colonic absorption: the importance of short chain fatty acids in man. Scandinavian Journal of Gastroenterology, 19(suppl 93),89-99.

Demigne C., Morand C., Levrat A.-M., Besson C., Moundras C. Rémésy C. (1995) Effect of propionate on fatty acid and cholesterol synthesis and on acetate metabolism in isolated rat hepatocytes. British Journal of Nutrition, 74, 209-219.

Eastwood, M. A. (1987). Dietary fiber and risk of cancer. Nutrition Reviews, 7, 193.

European Patent 0384238A2 Franco Bocelli (1990) Method for preparing a long-life fruitbased stuffing for pastry products.

Falade, K. O.; Igbeka, J. C. (2007) Osmotic Dehydration of Tropical Fruits and Vegetables. Food Reviews International 373-405

FAO/WHO, (1997) Carbohydrates in human nutrition, FAO Food and Nutrition Paper 66. Report of a Joint FAO/WHO Expert Consultation, Rome.

Fleming S. E., Marthinsen D., Kuhnlein H. (1983) Colonic function and fermentation in men consuming high fiber diets. Journal of Nutrition, 113, 2535-2544.

Harig J M, Soergel K H, Komorowski R A, Wood C M. (1989) Treatment of diversion colitis with short-chain-fatty acid irrigation. New England Journal of Medicine, 320, 23-8.

Khin, M. M.; Zhou, W.; Perera, C. (2005) Development in the Combined Treatment of Coating and Osmotic Dehydration of Food—A Review. International Journal of Food Engineering: Vol. 1: Iss. 1, Article 4.

McBurney M. I., Thompson L. U. (1987) Effect of human faecal inoculums on in vitro fermentation variables. British Journal of Nutrition, 58, 233-243.

McBurney, M. I., Horvath, P. J., Jeraci, J. L., Van Soest, P. J. (1985) Effect of in vitro fermentation using human faecal inoculum on the water-holding capacity of dietary fibre. British Journal of Nutrition, 53, 17-24.

Mendeloff, A. I. (1987). Dietary Fiber and gastrointestinal disease. American Journal of Clinical Nutrition, 45, 1267-1270.

Mortensen P. B., Holtug K, Rasmussen H. S. (1988) Short-chain fatty acid production from mono- and disaccharides in a fecal incubation system: implications for colonic fermentation of dietary fiber in humans. Journal of Nutrition, 32, 1-5.

Roediger W. E. W. (1980) Role of anaerobic bacteria in the metabolic welfare of the colonic mucosa in man. Gut, 21, 793-798.

Schweizer, T. F., Andwugrsch, P. (1991) The physiological and nutritional importance of dietary fibre. Experentia, 47, 181-186.

Shi, J.; Maguer, M. L. (2002) Osmotic dehydration of foods: Mass transfer and modeling aspects. Food Reviews International 18, 305-335

Tinker, L. F., Schneeman, B.O., Davis, P. A., Gallaher, D. D., Waggoner, C. R. (1991). Consumption of prunes as a source of dietary fiber in men with mild hypercholesterolemia. American Journal of Clinical Nutrition, 53, 1259-1265.

U.S. Pat. No. 4,041,184. Remigio Bonacia (1977) Method of candying fruit and fruit rinds.

U.S. Pat. No. 4,778,681. Kelzo Kuwabara (1988) Method for producing candied fruit and dried fruit.

The present invention is, of course, not in any way restricted to the embodiments described in this document and a person with average skills in the art may provide many possibilities of modifications thereof, without departing from the general scope of the invention as defined in the claims.

The embodiments described above are all combined together in a trivial matter.

The following claims define further preferred embodiments of the present invention.

1. A process for the production of candied products, comprising the following steps:
a) preparing the candying solution with a content of candying agent between 15 to 45 g per 100 g solution;
b) heating the solution prepared in the previous step;
c) preparing the product meant to be candied;
d) immersing the product meant to be candied into the solution with the candying agent;
e) gradually increasing the candying agent concentration up to a final value between 65 to 75 g candying agent per 100 g solution;
f) draining the product;
g) storing the product in a stabilizing solution containing 55 g candying agent per 100 g solution and 50 ppm benzoic acid and potassium sorbate.

2. The process according to claim 1, wherein the candying agent is fructose, mannose, galactose, galactosamine, sorbitol, xylitol, maltitol, erythritol, lactitol as candying agents and fructo-oligosaccharides, manno-oligosaccharides, galacto-oligosaccharides, gluco-oligosaccharides, xylo-oligosaccharides, pectin-oligosaccharides or other oligosaccharides.

3. The process according to claim 1, wherein the candying agents are used individually or in combination.

4. The process according to claim 1, wherein the candying solution further comprises a food-coloring agent.

5. The process according to claim 1, wherein the temperature in step b) varies from room temperature up to 85° C.

6. The process according to claim 1, wherein step c) comprises peeling and cutting the product meant to be candied.

7. The process according to claim 1, further comprising a step of removing excess water.

8. The process according to claim 7, wherein the removal of excess water is carried out by natural drying, hot air drying, infrared drying, microwave or lyophilization drying.

9. The process according to claim 1, wherein the product meant to be candied is a fruit or vegetable.

10. The process according to claim 9, wherein the fruit is cherries, figs, pineapple, peach, citron, orange peel, orange slices, or pear.

11. The process according to claim 8, wherein the vegetable is pumpkin, turnip or carrots.

12. Candied products, wherein they are obtained by the process according to claim 1.

13. A food product, comprising the candied product according to claim 12.

14. The process according to claim 2, wherein the candying agents are used individually or in combination.

15. The process according to claim 14, wherein the candying solution further comprises a food-coloring agent.

16. The process according to claim 15, wherein the temperature in step b) varies from room temperature up to 85° C.

17. The process according to claim 16, wherein step c) comprises peeling and cutting the product meant to be candied.

18. The process according to claim 17, further comprising a step of removing excess water.

19. The process according to claim 18, wherein the removal of excess water is carried out by natural drying, hot air drying, infrared drying, microwave or lyophilization drying.

20. Candied products, wherein they are obtained by the process according to claim 19.
